(19) United States
(12) Patent Application Publication
(10) Pub. No.: US 2007/0084260 A1
(43) Pub. Date: Apr. 19, 2007

(54) Rotary disc lock and key security system

(76) Inventor: Alfredo Muerza, Guipuzcoa (ES)

Correspondence Address: LUCAS & MERCANTI, LLP, 475 PARK AVENUE SOUTH, 15TH FLOOR, NEW YORK, NY, 10016, US

(21) Appl. No.: 11/249,532

(22) Filed: Oct. 13, 2005

(51) Int. Cl. E05B 29/04

(52) U.S. Cl. 70/366

(57) ABSTRACT

Rotary disc lock and key security device characterised in that, in the circular hollow centre of the said separator discs (5) there exist some projecting means (6) which are formed towards the inside and are arranged symmetrically relative to the path of entry of the shaft (2) of the key (1) into the lock, whilst in this shaft (2) there are some recessed means (7) which are reciprocal with the said projecting means (6), and are inter-penetrable with the latter by means of rotary adjustment, the said projecting means (6) operating in conjunction with the said recessed means (7) in relation to the rotary manoeuvre corresponding to the said first typical quarter-turn of the key (1) of rotary-disc locks, and the shaft (2) of which key (1) has, starting from its tip, a smooth area free from the said cut bevels (4), which has a length greater than the distance between two adjacent separator discs (5).

### FIELD OF THE INVENTION

This invention relates to a lock and key system based on rotary discs which is used extensively as a means for locking boxes and padlocks of motorcycles and their accessories.

### PRIOR STATE OF THE ART

These locking systems correspond to a general composition which comprises a plurality of combination discs which are each provided with conjugated rectangular central passages for the flat shaft of the key, in which passages there exists an edge which acts in combination with a respective bevel cut into this shaft, all such that at a first quarter-turn of the key all the combination discs are drawn forwards or backwards to a rotary position in which all of their peripheral notches are aligned with one another to form a continuous longitudinal depression which permits accommodation of a radially movable cotter, which until then had been interposed between the static body of the lock and a corresponding rotor, in the cavity of which this quarter-turn has been produced by a rotary body which accommodates the combination discs and incorporates the actuator body which gives rise to the opening of the mechanism of the lock, such that this rotor can now be rotated a further quarter-turn, which, when using the correct key, will give rise to this opening of the mechanism of the lock, and between each pair of adjacent combination discs there are interposed separator discs which cannot rotate, and have a completely circular central hole, the diameter of which is designed to exceed the largest transverse dimension of the shaft of the key, which can rotate freely in its cavity.

This composition has a major disadvantage consisting of the fact that, when its own key is introduced into one of these locks, although this introduction is incomplete, it is still possible to carry out the first quarter turn; then, users who are unaware of the fact that the key has not been introduced as far as it will go, carry out this first quarter turn, and, when trying to carry out the second turn which opens the mechanism of the lock, they find that they are unable to do so. Although the user is not aware of this, it is logical since the discs of the combination have not been matched with the respective bevels of the shaft of the key; the user may then think that the lock is awkward, and, by forcing the turn, will give rise to breakage of a type of key which, because of its particular design, is not very strong.

In this description, the first quarter-turn is used to set the combination, whereas the second quarter-turn is the actual active turn to give rise to the opening of the mechanism of the lock.

### EXPLANATION OF THE INVENTION AND ADVANTAGES

In view of this situation, the present invention proposes a lock and key system with rotary discs which has the specific feature that in the circular hollow centre of the separator discs there exist some projecting means which are formed towards the inside and are arranged symmetrically relative to the path of entry of the shaft of the key into the lock, whilst in this shaft there are some recessed means which are reciprocal with the said projecting means, and are inter-penetrable with the latter by means of rotary adjustment, the said projecting means operating in conjunction with the said recessed means in relation to the rotary manoeuvre corresponding to the said first typical quarter-turn of the key of rotary-disc locks, and the shaft of which key has, starting from its tip a smooth area free from the said cut bevels, which has a length greater than the distance between two adjacent separator discs. According to a preferred embodiment of this invention, the said projecting means are two flanges in the form of a segment of a circle, and at their ends they have a separation which is adapted with excess to the thickness of the flat shaft of the key, and the said recessed means are all grooves which are symmetrical with one another in a rotary manner and are adapted with excess to the thickness and radial size of the said flanges, which grooves are already provided along the shaft of the key in rough-cut form, corresponding to the number and position of the separator discs, and, in the virgin state of this shaft, before the bevels of the combination specific to each key are cut.

The functionality of the ingenious and simple invention is apparent. The said first 90° turn (putting into the combination position) can only be carried out when the correct key is introduced completely, since only then do the grooves cut in the shaft of this key coincide on the same transverse plane as the flanges of the separator discs, thus making it possible for the shaft of the key to rotate relative to the static separator discs, and, by means of the combination bevels cut in this shaft, to give rise to the said first 90° turn. Since the smooth tip of the shaft of the key is longer than the distance between two consecutive separator discs, until the key itself is fully inserted there will not take place the required matching of the grooves in the shaft with the separator discs of the channel for entry of the key in the rotary body; consequently, until that moment, it will not be possible to give rise to the first quarter-turn (putting into the combination position). Accordingly, nor can this first turn for putting into the combination position be carried out by any key which is not executed according to the invention.

In addition, this solution proposed does not presuppose any increased difficulty or cost in the production of the lock system, or at least nothing which is significant. This is because the separator discs are obtained by die-casting, and it is sufficient simply to use a die with the new form. The execution of the grooves in the shaft of the key is also a simple operation.

### DRAWINGS AND REFERENCES

In order better to understand the nature of the present invention, the attached drawings represent a preferred form of an industrial embodiment, which is in the nature purely of an illustrative and non-limiting example.

FIG. 1 shows a key 1 according to the invention, the tip of which is ready to be inserted into the rotary body 8, and which will have to be in the angular position which coincides with the angular position of the central passage 3a of the combination discs 3. This figure incorporates an enlarged detail which shows the series of combination discs 3 and separator discs 5, one of each of which is also reproduced by means of front views corresponding to those indicating the sections marked, of the sub-details of this enlarged detail of the set of discs 3 and 5.

FIG. 2 shows a separator disc 5 according to FIG. 1, but incorporating the section of the shaft 2 of the key 1.

FIG. 3 shows a combination disc 3 which is different from that which is shown in FIG. 1.

FIG. 4 shows a key 1 according to the invention in its rough or virgin state, before the combination bevels 4 are cut, and incorporating a partial enlargement of the shaft 2.

FIG. 5 is the key 1 in FIG. 4 once the combination bevels 4 have been cut. It incorporates a partial enlargement of the shaft 2.

FIG. 6 is a rough-cut key 1 of a conventional type, in contrast with the key 1 according to the invention shown in FIG. 4.

FIG. 7 is the key 1 in FIG. 6 once the bevels 4 have been cut.

FIG. 8 shows the key 1 in FIG. 1, once it has been introduced fully into the rotary body 8.

FIG. 9 is an enlargement of the detail IX which is shown circled in FIG. 8.

In these figures the following references are used:
1. Key
2. Shaft of the key 1
3. Combination discs
3a. Central passages of combination discs 3
3b. Peripheral mortice of combination discs 3
4. Bevels on the shaft 2
5. Separator discs
6. Flanges or projecting means of separator discs 5
7. Shaft entry means or grooves 2
8. Rotary body
9. Rotary body actuator member 9

### DESCRIPTION OF A PREFERRED EMBODIMENT

In relation to the aforementioned drawings and references, the attached drawings illustrate a preferred embodiment of the invention which relates to a rotary disc lock and key system, the general composition of which comprises a plurality of combination discs 3 which are each provided with rectangular central passages 3a which are conjugated with the flat shaft 2 of the key 1, in which there is an edge which acts in combination with a respective bevel 4 cut into this shaft 2, all such that at a first quarter-turn of the key 1 all the combination discs 3 are drawn forwards or backwards to a rotary position in which all of their peripheral notches 3b are aligned with one another to form a continuous longitudinal depression which permits accommodation of a radially mobile cotter, which until then had been interposed between the static body of the lock and a corresponding rotor, in the cavity of which this quarter-turn has been produced by a rotary body 8 which accommodates the combination discs 3 and incorporates the actuator body 9 which gives rise to the opening of the mechanism of the lock, such that this rotor can now be rotated a further quarter-turn, which, when using the correct key, will give rise to this opening of the mechanism of the lock, and between each pair of adjacent combination discs 3 there are interposed separator discs 5 which cannot rotate, and have a completely circular central hole, the diameter of which is designed to exceed the largest transverse dimension of the shaft 2 of the key 1, which can rotate freely in its cavity.

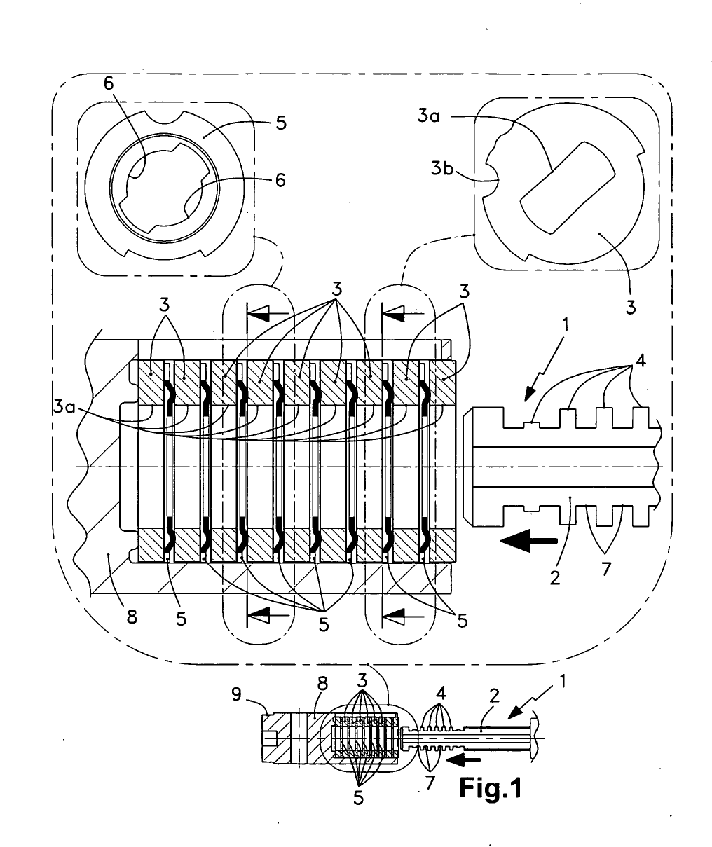

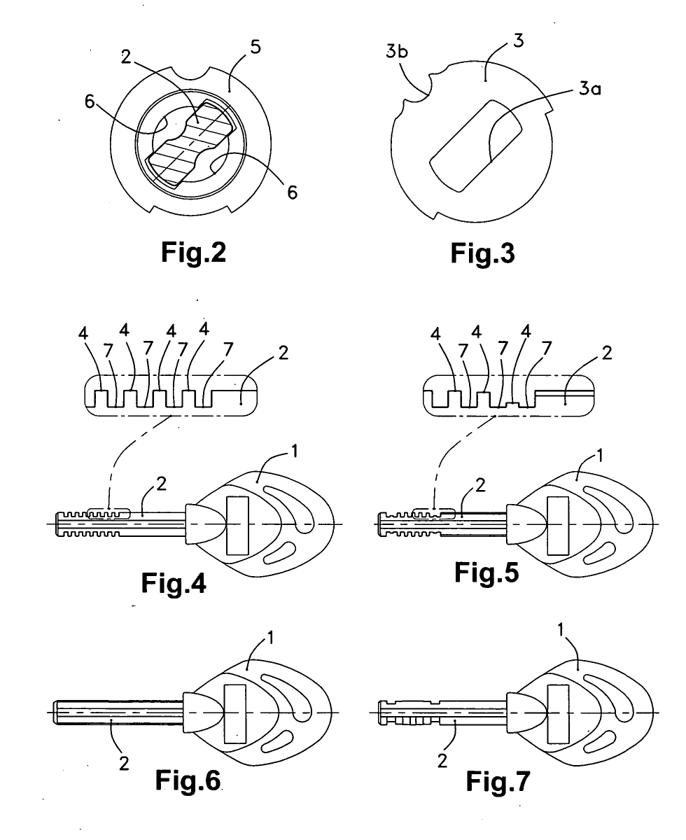

In these lock systems, it is usual for the intake channel for the key 1 to be produced in a position at 45°, as shown in FIG. 2. The new visual contrast of the combination discs 3 represented in FIGS. 1 and 3 makes it possible to appreciate the different rotary position occupied in each case by the peripheral mortice 3b, of 5° and 45° respectively relative to the horizontal, in the third quadrant and in a clockwise direction; this means that, for the putting into the combination position carried out after the first 90° turn, the first combination disc 3 will have to travel 85° and the second will only have to travel 45°, such that the bevel 4 of the latter will have to correspond to an angle of 45°, whereas that of the first will correspond to an angle of 5°.

With reference to this general composition of rotary disc locking systems, the object of the invention consists in that (FIG. 1), in the circular hollow centre of the said separator discs 5 there exist some projecting means 6 which are formed towards the inside and are arranged symmetrically relative to the path of entry of the shaft 2 of the key 1 into the lock, whilst in this shaft 2 there are some recessed means 7 which are reciprocal with the said projecting means 6, and are inter-penetrable with the latter by means of rotary adjustment, the said projecting means 6 operating in conjunction with the said recessed means 7 in relation to the rotary manoeuvre corresponding to the said first typical quarter-turn of the key 1 of rotary-disc locks, and the shaft 2 of which key 1 has, starting from its tip, a smooth area free from the said cut bevels 4, which has a length greater than the distance between two adjacent separator discs 5. In particular the invention includes a preferred embodiment wherein the said projecting means 6 are two flanges 6 in the form of a segment of a circle, and at their ends they have a separation which is adapted with excess to the thickness of the flat shaft 2 of the key 1, and the said recessed means are all grooves 7 which are symmetrical with one another in a rotary manner and are adapted with excess to the thickness and radial size of the said flanges 6, which grooves 7 are already provided along the shaft 2 of the key 1 in rough-cut form, corresponding to the number and position of the separator discs 5, and, in the virgin state of this shaft 2, before the bevels 4 of the combination specific to each key 1 are cut.

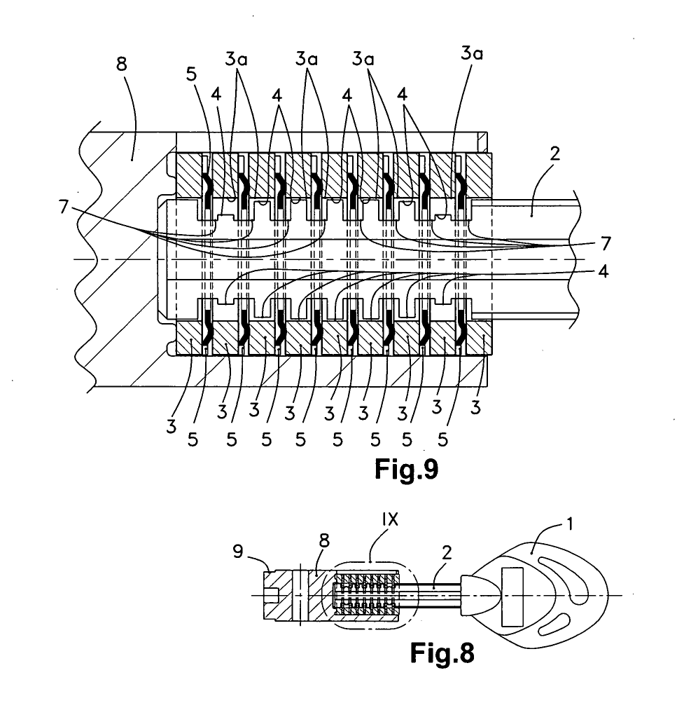

According to this new constitution of the separator discs 5 in conjunction with the shaft 2 of the key 1, when (FIG. 2) this shaft 2 of the key 1 is introduced, its position is connected collaterally between the ends of the flanges 6 and it cannot rotate (it should be remembered that the separator discs are static); it can rotate only when, according to the invention, in association with the said flanges 6, a corresponding groove 7 exists in the shaft 2. Consequently, only when the correct key is introduced fully into the rotary body 8 do all of the separator discs 5 have their flanges 6 matching grooves 7 in the shaft 2, and the latter can carry out the first 90° turn, which, by means of the bevels 4, gives rise to the putting into the combination position which will make it possible to carry out the second 90° turn, by means of which the actuator member 9 of the rotary body 8 causes the opening of the mechanism of the lock. The state of total penetration of the shaft 2 of the key 1 in the rotary body is illustrated by means of FIGS. 8 and 9.

A specific feature of the invention is that it can be distinguished visually simply by looking at a key 1 in the uncut or virgin state. The type used hitherto will have a shaft 2 which is completely smooth; whereas the key 1 according to the invention will have toothing corresponding to the pre-production of the grooves 7 at the moment when the key leaves the production chain. This specific feature is the one illustrated in FIGS. 4 and 6; FIGS. 5 and 7 are the cut states which correspond respectively to FIGS. 4 and 6.

1. Rotary disc lock and key security device comprising a plurality of combination discs (3) which are each provided with central passages (3a) for the flat shaft (2) of the key (1), in which there is an edge which acts in combination with a respective bevel (4) cut into this shaft (2), all such that at a first quarter-turn of the key (1) all the combination discs (3) are drawn forwards or backwards to a rotary position in which all of their peripheral notches (3b) are aligned with one another to form a continuous longitudinal depression which permits accommodation of a radially mobile cotter, which until then had been interposed between the static body of the lock and a corresponding rotor, in the cavity of which this quarter-turn has been produced by a rotary body (8) which accommodates the combination discs (3) and incorporates the actuator body (9) which gives rise to the opening of the mechanism of the lock, such that this rotor can now be rotated a further quarter-turn, which, when using the correct key, will give rise to this opening of the mechanism of the lock, and between each pair of adjacent combination discs (3) there are interposed separator discs (5) which cannot rotate, and have a completely circular central hole, the diameter of which is designed to exceed the largest transverse dimension of the shaft (2) of the key (1), which can rotate freely in its cavity, characterised in that in the circular hollow centre of the said separator discs (5) there exist some projecting means (6) which are formed towards the inside and are arranged symmetrically relative to the path of entry of the shaft (2) of the key (1) into the lock, whilst in this shaft (2) there are some recessed means (7) which are reciprocal with the said projecting means (6), and are inter-penetrable with the latter by means of rotary adjustment, the said projecting means (6) operating in conjunction with the said recessed means (7) in relation to the rotary manoeuvre corresponding to the said first typical quarter-turn of the key (1) of rotary-disc locks, and the shaft (2) of which key (1) has, starting from its tip, a smooth area free from the said cut bevels (4), which has a length greater than the distance between two adjacent separator discs (5).

2. Rotary disc lock and key security device according to claim 1, characterised in that the said projecting means are two flanges (6) in the form of a segment of a circle, and at their ends they have a separation which is adapted with excess to the thickness of the flat shaft (2) of the key (1), and the said recessed means are all grooves (7) which are symmetrical with one another in a rotary manner and are adapted with excess to the thickness and radial size of the said flanges (6), which grooves (7) are already provided along the shaft (2) of the key (1) in rough-cut form, corresponding to the number and position of the separator discs (5), and, in the virgin state of this shaft (2), before the bevels (4) of the combination specific to each key (1) are cut.

3. Rotary disc lock and key security device according to claim 1 characterised in that, in the circular hollow centre of the said separator discs (5) there exist some projecting means (6) which are formed towards the inside and are arranged symmetrically relative to the path of entry of the shaft (2) of the key (1) into the lock, whilst in this shaft (2) there are some recessed means (7) which are reciprocal with the said projecting means (6), and are inter-penetrable with the latter by means of rotary adjustment, the said projecting means (6) operating in conjunction with the said recessed means (7) in relation to the rotary manoeuvre corresponding to the said first typical quarter-turn of the key (1) of rotary-disc locks, and the shaft (2) of which key (1) has, starting from its tip, a smooth area free from the said cut bevels (4), which has a length greater than the distance between two adjacent separator discs (5).
